(19) United States
(12) Patent Application Publication
(10) Pub. No.: US 2011/0011778 A1
(43) Pub. Date: Jan. 20, 2011

(54) BANKNOTE STORING CASSETTE AND BANKNOTE HANDLING MACHINE

(76) Inventors: Norishige Inoue, Hyogo-Ken (JP); Kazuhiko Takahashi, Hyogo-Ken (JP); Keiju Nakagawa, Hyogo-Ken (JP)

Correspondence Address: RENNER KENNER GREIVE BOBAK TAYLOR & WEBER, FIRST NATIONAL TOWER, SUITE 400, 106 SOUTH MAIN STREET, AKRON, OH, 44308-1412, US

(21) Appl. No.: 12/736,334

(22) PCT Filed: Mar. 31, 2008
(86) PCT No.: PCT/JP2008/056357

§ 371 Date: Sep. 29, 2010

(51) Int. Cl. B07C 5/34; B65H 31/00; B65H 5/00; B65H 29/00

(52) U.S. Cl. 209/534; 271/279

(57) ABSTRACT

A banknote storing cassette (30) includes: a banknote inlet (38a) provided to a cassette casing; one or more first banknote storing units (34, 36), at least one of the first banknote storing units storing therein genuine banknotes; and a second banknote storing unit (32) provided for storing therein counterfeit banknotes or suspicious banknotes about the authentication. A banknote handling machine (10) includes: a main-body casing (11a, 11b); a banknote inlet unit (12); a transport unit (22) adapted for transporting each banknote inserted in the banknote inlet unit (12); a recognition unit (18) adapted for recognizing each banknote transported by the transport unit (22); and the aforementioned banknote storing cassette (30) provided for receiving the banknotes respectively transported from the transport unit (22), the banknote storing cassette (30) can be optionally detached from the casing (11b), and each banknote transported to the banknote storing cassette (30) can be sent to the first banknote storing units (34, 36) or second banknote storing unit (32), based on a recognition result on the banknote recognized by the recognition unit (18).

### FIELD OF THE INVENTION

The present invention relates to a banknote storing cassette and a banknote handling machine including the banknote storing cassette, and in particular relates to the banknote storing cassette and banknote handling machine, respectively capable of enhancing the efficiency of task of collecting banknotes from the banknote handling machine.

### BACKGROUND OF THE INVENTION

In the past, as a banknote deposit machine for use in a financial institution or the like, a machine as disclosed in, for example, JP2004-213560A and the like, has been known. In the conventional banknote deposit machine of this type, the banknotes respectively inserted in a banknote inlet by a customer are taken into a casing of the machine, and then such banknotes taken in the casing are respectively recognized by a recognition unit about the denomination, authentication, fitness and the like thereof. Thereafter, the banknotes recognized by the recognition unit are escrowed (or temporarily stored) in an escrow unit. In this case, when an instruction of storing the banknotes into a storing unit is given to the banknote deposit machine, the banknotes escrowed in the escrow unit are transported to the storing unit, respectively.

This storing unit is composed of a plurality of (e.g., two) genuine banknote storing cassettes, respectively provided for storing therein genuine banknotes, for example, by denomination thereof, a counterfeit-banknote storing cassette provided for storing therein counterfeit banknotes and/or suspicious banknotes about the authentication, and a storing-unit base configured for placing thereon the genuine banknote storing cassettes and counterfeit-banknote storing cassette. In this case, the two genuine banknote storing cassettes are respectively provided in front and rear portions of the storing unit, while the counterfeit-banknote storing cassette is provided between the front genuine banknote storing cassette and the rear genuine banknote storing cassette. With this configuration, the banknotes transported from the escrow unit to the storing unit are respectively sorted and sent to either one of the two genuine banknote storing cassettes or counterfeit-banknote storing cassette, based on recognition results on the banknotes respectively recognized by the recognition unit. The storing-unit base is stored in the casing of the banknote deposit machine, such that this storing-unit base can be optionally pulled out to the outside from the casing.

### DISCLOSURE OF THE INVENTION

In such a conventional banknote handling machine as disclosed in the above 3P2004-213560A and the like, the two genuine banknote storing cassettes are provided in the storing unit, such that these genuine banknote storing cassettes can be respectively detached from the storing-unit base. Meanwhile, the counterfeit-banknote storing cassette is fixed to the storing-unit base. Thus, for collecting the banknotes respectively stored in the storing unit of this banknote handling machine, it is necessary to pull out the storing-unit base to the outside from the casing of the banknote deposit machine, and then detach the two genuine banknote storing cassettes from the storing-unit base, and then collect the banknotes from the respectively detached genuine banknote storing cassettes as well as collect the banknotes from the counterfeit-banknote storing cassette fixed to the storing-unit base. Namely, for collecting the banknotes from such a conventional banknote handling machine, it is necessary to perform the task of collecting the banknotes, many times, thus leading to undue deterioration of the working efficiency.

The present invention was made in light of the above problem, and therefore it is an object of this invention to provide a banknote storing cassette that can allow one or more banknote storing units for storing therein the genuine banknotes and another banknote storing unit for storing therein the counterfeit banknotes or suspicious banknotes about the authentication to be collectively provided in the single banknote storing cassette, thereby allowing the banknotes to be collected, all at once, from the banknote handling machine, thus significantly enhancing the efficiency of the task of collecting the banknotes from the banknote handling machine.

It is another object of the present invention to provide a banknote handling machine including the above banknote storing cassette and the banknote storing cassette can be optionally detached from the main-body casing. Therefore, when collecting the banknotes from the banknote handling machine, the genuine banknotes and counterfeit banknotes or suspicious banknotes about the authentication can be collected, all at once, from the banknote storing cassette, in any suitable place, by detaching the banknote storing cassette from the main-body casing and then carrying this banknote storing cassette to the place. This can significantly enhance the efficiency of the task of collecting the banknotes from the banknote handling machine.

A banknote storing cassette of the present invention includes: a cassette casing; a banknote inlet provided to the cassette casing; one or more first banknote storing units, to which one or more banknotes inserted in the banknote inlet are sent, at least one of the one or more first banknote storing units storing therein genuine banknotes; and a second banknote storing unit, to which one or more banknotes inserted in the banknote inlet are sent, the second banknote storing unit storing therein counterfeit banknotes or suspicious banknotes about the authentication.

In the banknote storing cassette of the present invention, it is preferable that the banknote storing cassette further includes a switching unit configured to switch the banknote storing unit to which one or more banknotes inserted in the banknote inlet are sent, between the first banknote storing unit and the second banknote storing unit.

In the banknote storing cassette of the present invention, it is preferable that a transport path from the banknote inlet to the second banknote storing unit is provided in a substantially linear form. In this case, it is further preferable that the banknote inlet is provided in a top face of the cassette casing and the second banknote storing unit is located below the banknote inlet.

In the banknote storing cassette of the present invention, it is preferable that the banknote storing cassette further includes a memory unit configured to store therein information concerning the banknotes respectively stored in the one or more first banknote storing units and the second banknote storing unit. In this case, it is further preferable that the banknote storing cassette further including a transmission unit configured to transmit the information stored in the memory unit to the exterior of the banknote storing cassette.

In the banknote storing cassette of the present invention, it is preferable that the one or more first banknote storing units can be optionally detached from the cassette casing. It is also preferable that the second banknote storing unit can be optionally detached from the cassette casing.

A banknote handling machine of the present invention including: a main-body casing; a banknote inlet unit provided to the main-body casing; a transport unit provided in the main-body casing and configured to transport each banknote inserted in the banknote inlet unit, in the main-body casing; a recognition unit provided to the transport unit and configured to recognize each banknote transported by the transport unit; and the banknote storing cassette described above and connected to the transport unit to receive the banknotes respectively transported from the transport unit, the banknote storing cassette can be optionally detached from the main-body casing, and each banknote transported to the banknote storing cassette is sent to any one of the one or more first banknote storing units and the second banknote storing unit, based on a recognition result on the banknote recognized by the recognition unit.

In the banknote handling machine of the present invention, it is preferable that a slide rail extending in a substantially horizontal direction is provided in the main-body casing, a guide member configured to be placed on the slide rail is attached to a side face of the cassette casing of the banknote storing cassette, and the banknote storing cassette can be pulled out from the main-body casing, along the slide rail, by moving the banknote storing cassette in the substantially horizontal direction.

In this case, it is further preferable that the slide rail can be moved relative to the main-body casing, and is provided with an engaged member, an engaging member that can engage with the engaged member is provided to the main-body casing, and when the engaging member engages with the engaged member, the slide rail becomes fixed to the main-body casing, while when the engaging member is disengaged from the engaged member, the slide rail can be pulled out, together with the banknote storing cassette, from the main-body casing. In such a situation, it is further preferable the engaging member can be pivoted, about an attachment shaft, relative to the main-body casing, and the engaging member can engage with or be disengaged from the engaged member by pivoting the engaging member about the attachment shaft.

In the banknote handling machine of the present invention, it is preferable that the banknote handling machine further includes an escrow unit provided in the main-body casing and configured to escrow therein the banknotes, and each banknote recognized by the recognition unit is escrowed in the escrow unit, and then the escrowed banknote is transported to the banknote storing cassette by the transport unit.

### BRIEF DESCRIPTION OF THE DRAWINGS

FIG. 1 is a perspective view showing a construction of a banknote handling machine related to one embodiment of the present invention.

FIG. 2 is a diagram illustrating the general construction of the interior of the banknote handling machine shown in FIG. 1.

FIG. 3 is a block diagram illustrating a control system of the banknote handling machine shown in FIGS. 1 and 2.

FIG. 4 is a perspective view showing a construction of a banknote storing cassette detachably provided to the banknote handling machine shown in FIG. 1.

FIG. 5 is a diagram illustrating the general construction of the interior of the banknote storing cassette shown in FIG. 4.

FIG. 6 is a diagram illustrating the general construction of the interior of another banknote storing cassette related to the present invention.

FIG. 7 is a back view of the banknote storing cassette shown in FIG. 4, when this cassette is seen from the back thereof, while being stored in the banknote handling machine shown in FIG. 1.

FIG. 8 is a diagram for illustrating a relationship between an engaging member provided to a main-body casing of the banknote handling machine and an engaged member provided to a slide rail.

FIG. 9 is a diagram for illustrating another relationship between the engaging member provided to the main-body casing of the banknote handling machine and the engaged member provided to the slide rail.

### DETAILED DESCRIPTION OF THE INVENTION

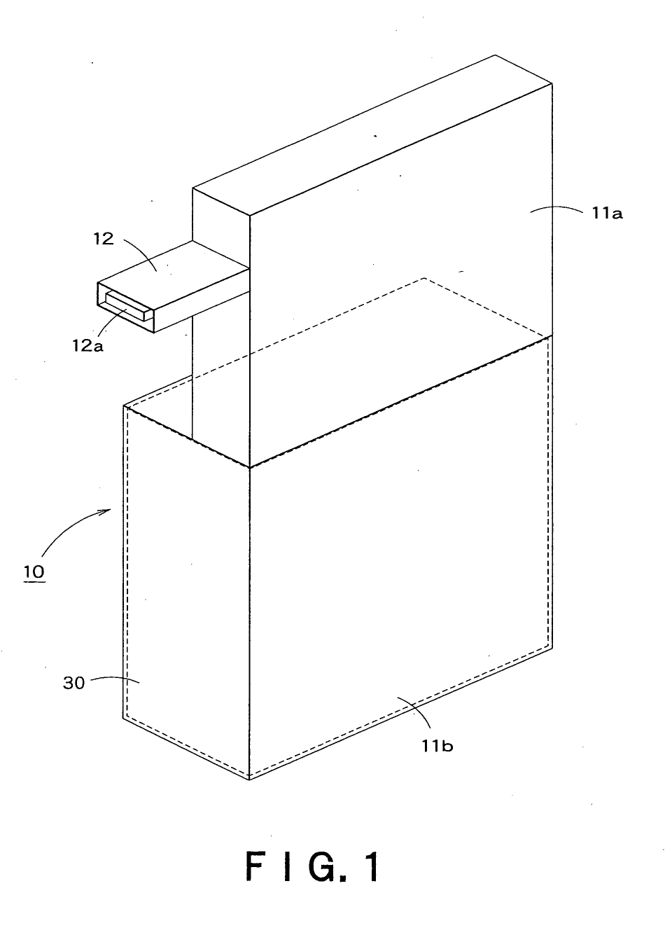

Hereinafter, one embodiment of the present invention will be described with reference to the drawings. FIGS. 1 through 9 are respectively provided for showing the banknote handling machine related to this embodiment.

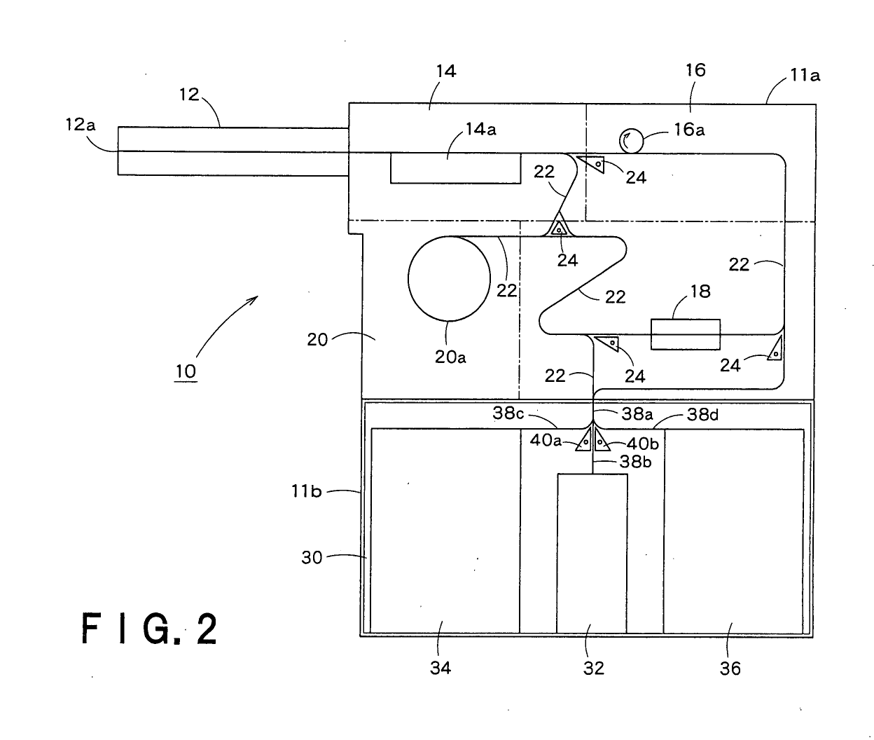

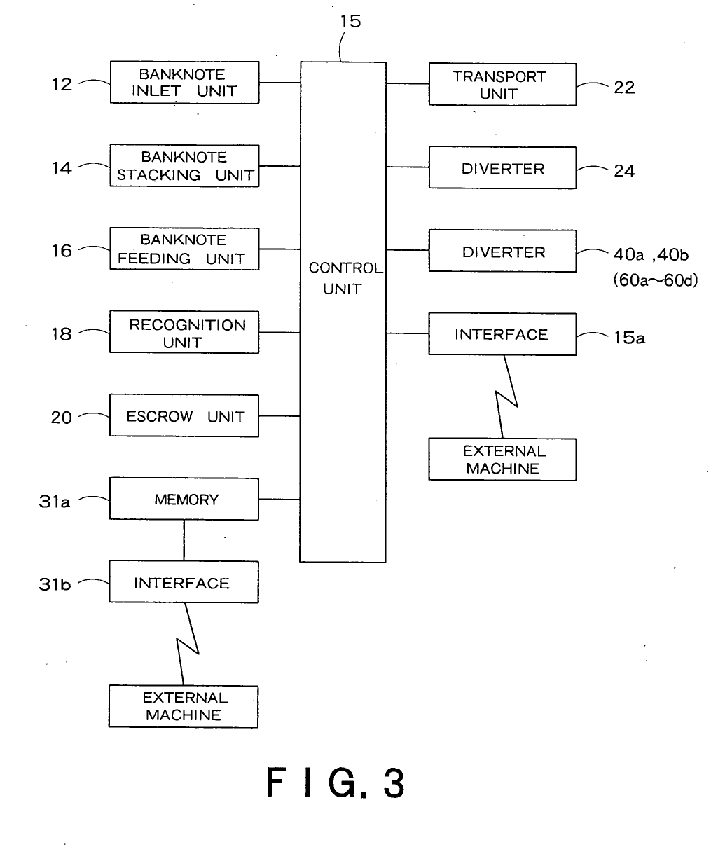

First, referring to FIGS. 1 through 3, the general construction of the banknote handling machine related to this embodiment will be discussed. FIG. 1 is a perspective view showing the construction of the banknote handling machine related to this embodiment, FIG. 2 is a diagram illustrating the general construction of the interior of the banknote handling machine shown in FIG. 1. FIG. 3 is a block diagram illustrating a control system of the banknote handling machine shown in FIGS. 1 and 2.

As shown in FIG. 1, the banknote handling machine 10 includes an upper casing 11a of a substantially rectangular shape, and a lower casing 11b having another substantially rectangular shape and located below and attached to the upper casing 11a. Namely, such upper and lower casings 11a, 11b constitute together the main-body casing of the banknote handling machine 10. As shown in FIG. 1, a banknote inlet unit 12 configured for allowing the banknotes to be respectively taken into the banknote handling machine 10 is provided to the upper casing 11a of the banknote handling machine 10. In the upper casing 11a, a banknote stacking unit 14 configured for stacking therein the banknotes respectively inserted in the banknote inlet unit 12, a banknote feeding unit 16 adapted for feeding out the banknotes from the banknote stacking unit 14, a transport unit 22 adapted for transporting the banknotes respectively fed out by the banknote feeding unit 16, a recognition unit 18 adapted for recognizing each banknote transported by the transport unit 22, and an escrow unit 20 configured for escrowing therein the banknotes respectively recognized by the recognition unit 18 are provided, respectively.

Meanwhile, in the lower casing 11b of the banknote handling machine 10, a banknote storing cassette 30 is provided for storing therein the banknotes. The banknote storing cassette 30 is configured for receiving the respective banknotes once escrowed in the escrow unit 20 and then transported by the transport unit 22. The banknote storing cassette 30 can be optionally detached from the lower casing 11b of the banknote handling machine 10. Thus, in the perspective view of the banknote handling machine 10 shown in FIG. 1, the banknote storing cassette 30 can be pulled out backward from the lower casing 11b.

In addition, each component of this banknote handling machine 10 can be controlled by a control unit 15.

Now, each component of the banknote handling machine 10 will be described in detail.

As shown in FIGS. 1 and 2, the banknote inlet unit 12 is provided to be projected forward from a front face of the upper casing 11a of the banknote handling machine 10. A banknote inlet 12a is provided to a distal end of the banknote inlet unit 12, such that the customer or the like can insert a batch of the banknotes in this banknote inlet 12a. Further, the banknote inlet unit 12 includes a pair of upper and lower circulating belt mechanisms (not shown), such that the batch of the banknotes inserted through the banknote inlet 12a can be taken into the upper casing 11a, while being held between such circulating belt mechanisms. In this case, each circulating belt mechanism is composed of a pair of or three or more rollers and proper belts, such as rubber belts or the like, respectively provided over the respective rollers. As shown in FIG. 2, the batch of the banknotes once inserted in the banknote inlet 12a are then sent to the banknote stacking unit 14 that will be described later. It should be noted that the banknote inlet unit 12 can serve to take the batch of the banknotes from the exterior into the upper casing 11a of the banknote handling machine 10, as well as can serve to send the batch of the banknotes once stacked in the banknote stacking unit 14 toward the banknote inlet 12a, thus allowing this batch of the banknotes to be returned to the exterior from the banknote inlet 12a.

The banknote stacking unit 14 is located in the upper casing 11a of the banknote handling machine 10, such that the banknotes inserted in the banknote inlet unit 12 can be first sent to this banknote stacking unit 14. This banknote stacking unit 14 includes a banknote stacking mechanism 14a configured for allowing each batch of the banknotes to be stacked therein. With this configuration, the batch of the banknotes inserted in the banknote inlet unit 12 can be once stacked in the banknote stacking mechanism 14a, and then such stacked banknotes can be sent, in a batch form, to the banknote feeding unit 16 that will be described later, by circulating belt mechanisms (not shown) or the like, from the banknote stacking mechanism 14a. Further, the banknotes once escrowed in the escrow unit 20 can also be sent, one by one, to the banknote stacking unit 14. In this case, the banknotes sent from the escrow unit 20 are once stacked in the banknote stacking mechanism 14a, and then such stacked banknotes are sent, in the batch form, to the banknote inlet unit 12 from the banknote stacking mechanism 14a. Then, as described above, each batch of the banknotes sent to the banknote inlet unit 12 from the banknote stacking unit 14 will be returned to the exterior of the banknote handling machine 10 from the banknote inlet 12a.

The banknote feeding unit 16 is also located in the upper casing 11a of the banknote handling machine 10, and is adapted for feeding the batch of the banknotes sent from the banknote stacking unit 14, one by one, to the transport unit 22. More specifically, this banknote feeding unit 16 includes a reverse roller 16a that can be rotated in a direction depicted by an arrow in FIG. 2, and circulating belt mechanisms (not shown) respectively located, with a slight gap provided between the reverse roller 16a and the circulating belt mechanisms. Thus, each batch of the banknotes sent from the banknote stacking unit 14 to the banknote feeding unit 16 can be fed, one by one, to the transport unit 22, through the gap between the reverse roller 16a and the circulating belt mechanisms. Further, the banknote feeding unit 16 can also serve to directly return the batch of the banknotes, once sent thereto from the banknote stacking unit 14, to this banknote stacking unit 14.

Further, the transport unit 22 is located in the upper casing 11a of the banknote handling machine 10, and is adapted for transporting the banknotes fed out from the banknote feeding unit 16, one by one, along each transport path thereof, to the escrow unit 20 that will be described later or banknote stacking unit 14. Further, this transport unit 22 can serve to transport the banknotes once escrowed in the escrow unit 20 to the banknote stacking unit 14 or banknote storing cassette 30 stored in the lower casing 11b of the banknote handling machine 10. For instance, this transport unit 22 is composed of a proper combination of circulating belt mechanisms.

As shown in FIG. 2, diverters 24 are provided at diversion points of each transport path of the transport unit 22, such that the transport route of the banknotes can be optionally switched by the diverters 24. This switching operation of each transport route of the banknotes performed by each corresponding diverter 24 can be controlled by the control unit 15 that will be described later.

Further, as shown in FIG. 2, the recognition unit 18 is provided to the transport path of the transport unit 22. This recognition unit 18 can serve to recognize the banknotes, one by one, about the denomination, authentication, fitness and the like thereof, after the banknotes are fed out, one by one, from the banknote feeding unit 16 to the transport unit 22. In this case, the recognition result on each banknote recognized by the recognition unit 18 is sent to the control unit 15 that will be described later.

The escrow unit 20 is also located in the upper casing 11a of the banknote handling machine 10, and is configured for receiving the banknotes, which have been fed out, one by one, from the banknote feeding unit 16 to the transport unit 22 and then recognized, one by one, by the recognition unit 18. This escrow unit 20 is provided for escrowing all of the banknotes respectively fed out from the banknote feeding unit 16 to the transport unit 22, regardless of the recognition result on each banknote recognized by the recognition unit 18. As shown in FIG. 2, the escrow unit 20 includes a drum 20a that can be rotated in both of forward and backward directions, and a pair of tapes can be wound around this drum 20a. Namely, with this configuration, each banknote sent to the escrow unit 20 from the transport unit 22 can be wound around the drum 20a, successively, one by one, while being held between the pair of tapes.

More specifically, the drum 20a of the escrow unit 20 can be rotated, in both of clockwise and anticlockwise directions in FIG. 2, about an axis orthogonal to the sheet of FIG. 2. Each one end of the pair of tapes is attached to the same point on the outer circumferential face of the drum 20a. Therefore, with anticlockwise rotation of the drum 20a in FIG. 2, such a pair of tapes can be wound around the drum 20a. This operation of the drum 20a can be controlled by the control unit 15 that will be described later. In this way, each banknote sent from the transport unit 22 to the escrow unit 20 can be wound, one by one, around the drum 20a, together with the pair of tapes, while being held between such tapes, with the anticlockwise rotation of the drum 20a in FIG. 2. In this case, the plurality of banknotes can be wound, one by one, around the drum 20a, with a proper interval provided therebetween. Meanwhile, with the clockwise rotation of the drum 20a in FIG. 2, the pair of tapes once wound around the drum 20a will be released therefrom, as such each banknote once escrowed in the escrow unit 20 can be returned to the transport unit 22.

As described above, the plurality of banknotes, respectively wound around the drum 20a while being held between the pair of tapes, have been already recognized by the recognition unit 18. In this case, the information on the order in which each banknote has been wound around the drum 20a, as well as on the recognition result on this banknote recognized by the recognition unit 18, has been stored in the control unit 15. Thus, when the banknotes once wound around the drum 20a are returned to the transport unit 22, such banknotes will be returned to the transport unit 22, in the order reverse to the order, stored in the control unit 15, in which the banknotes have been respectively wound around the drum 20a. Namely, the banknote that has been wound first around the drum 20a, while being held between the pair of tapes, will be returned last to the transport unit 22 from the escrow unit 20.

It should be noted that the escrow unit 20 is not limited to such a configuration that is composed of the drum and pair of tapes, as described above, and is configured for enabling each banknote to be wound around the drum, together with the pair of tapes, while this banknote is held between such tapes. Namely, this escrow unit 20 may have any other suitable configuration. For instance, the escrow unit 20 may be provided as a stacker type unit.

The banknote storing cassette 30 is stored in the lower casing 11b of the banknote handling machine 10, such that the banknotes once escrowed in the escrow unit 20 can be respectively sent to this banknote storing cassette 30 by the transport unit 22. As described above, the banknote storing cassette 30 can be optionally detached from the lower casing 11b of the banknote handling machine 10. Namely, this banknote storing cassette 30 can be pulled out from the lower casing 11b, in a suitable direction, e.g., backward, in the perspective view of the banknote handling machine 10 shown in FIG. 1 (or this banknote storing cassette 30 can be pulled out, rightward in FIG. 2, from the lower casing 11b).

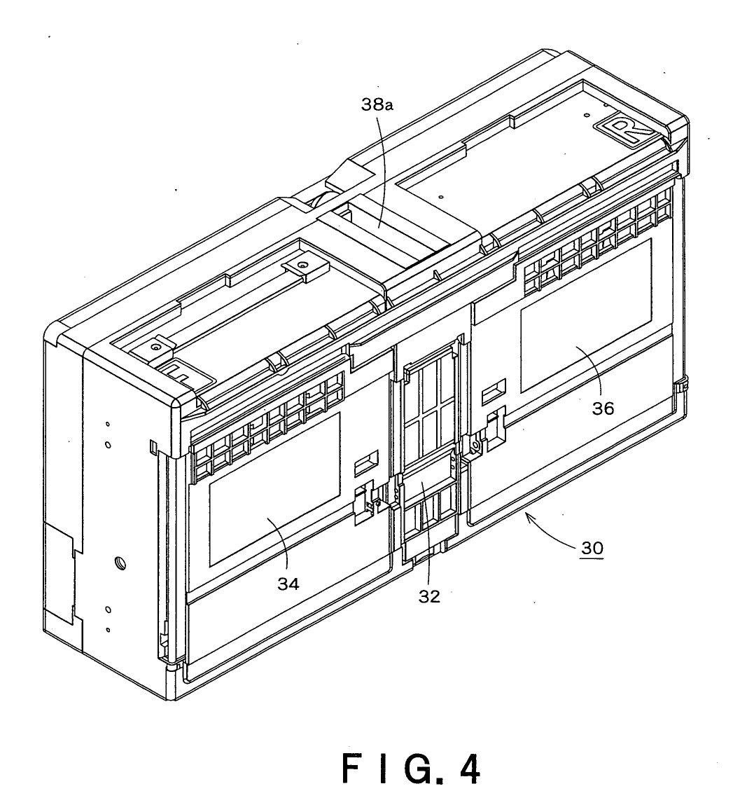

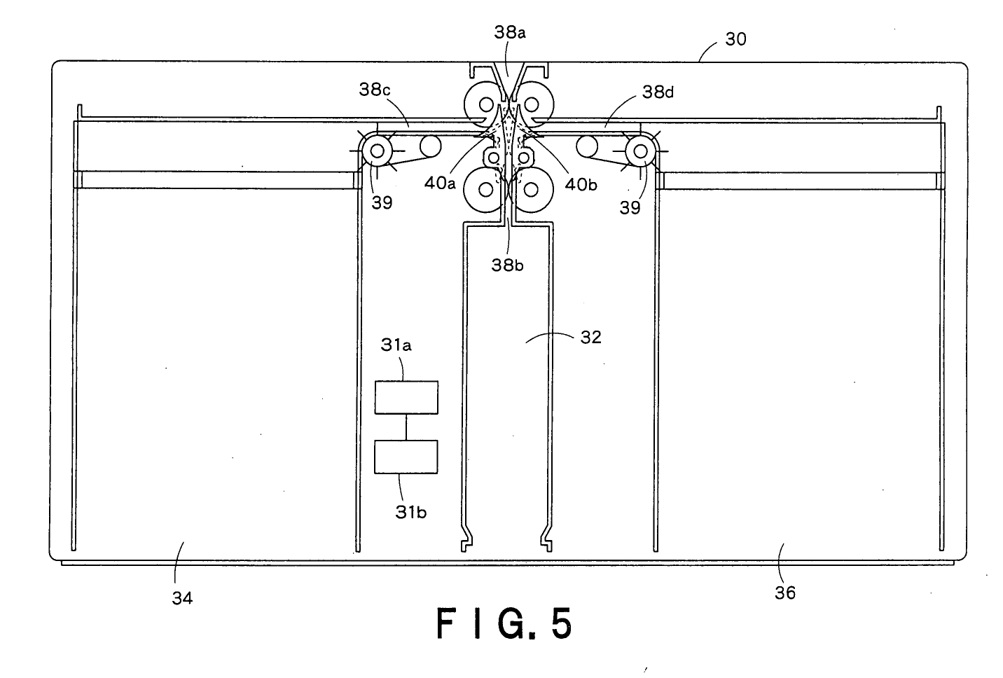

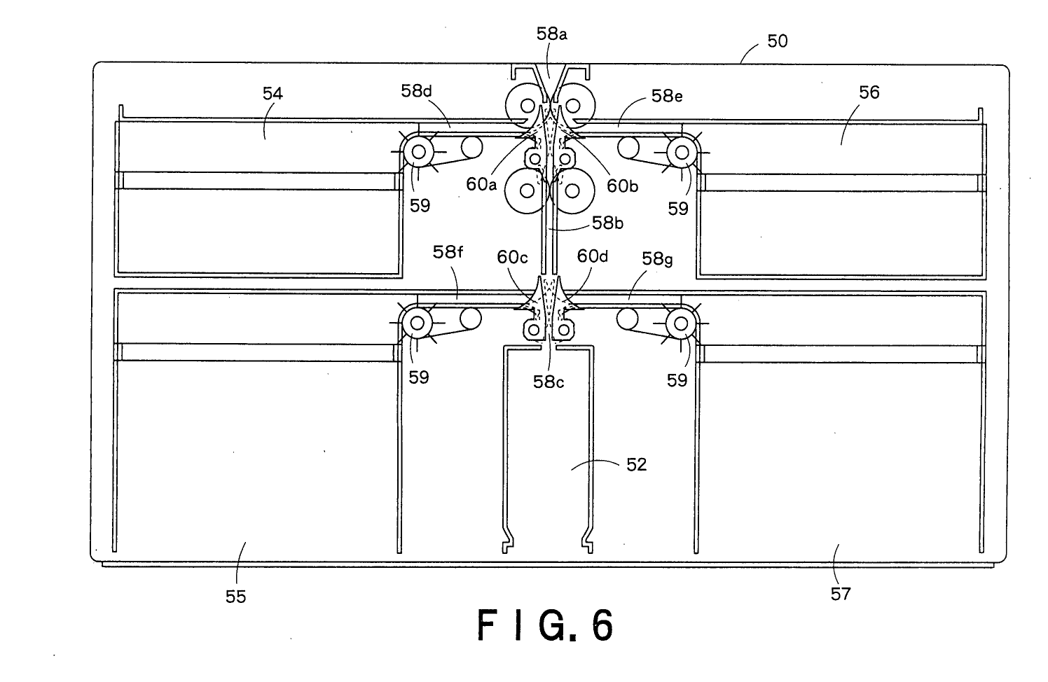

Now, referring to FIGS. 4 though 6, the construction of the banknote storing cassette 30 will be described in more detail. Of these drawings, FIG. 4 is the perspective view showing the construction of the banknote storing cassette 30, FIG. 5 is the diagram illustrating the general construction of the interior of the banknote storing cassette 30 shown in FIG. 4, and FIG. 6 is the diagram illustrating the general construction of the interior of another banknote storing cassette 50 related to the present invention.

As shown in FIG. 4, the banknote storing cassette 30 includes a cassette casing of a substantially rectangular shape, and has a banknote inlet 38a provided in a top face of the cassette casing. Further, the banknote storing cassette 30 includes a front banknote storing unit 34 provided in a front position, a rear banknote storing unit 36 provided in a rear position, and a middle banknote storing unit 32 provided between the front banknote storing unit 34 and the rear banknote storing unit 36. Each of the banknote storing units 32, 34, 36 is configured to receive the banknotes, one by one, after such banknotes are respectively inserted in the banknote inlet 38a from the transport unit 22.

At least one of the front banknote storing unit 34 and rear banknote storing unit 36 (preferably both of the units 34 and 36) is provided for storing therein the banknotes respectively recognized, as the genuine banknotes, by the recognition unit 18. Meanwhile, the middle banknote storing unit 32 is provided for storing therein the banknotes respectively recognized, as the counterfeit banknotes or suspicious banknotes about the authentication, by the recognition unit 18.

Now, the internal construction of the banknote storing cassette 30 will be described with reference to FIG. 5. As shown in FIG. 5, each banknote inserted in the banknote inlet 38a will be sent to any one of three transport paths 38b, 38c, 38d, by the diverters 40a, 40b. In this case, the transport path 38b is connected to the middle banknote storing unit 32, the transport path 38c is connected to the front banknote storing unit 34, and the transport path 38d is connected to the rear banknote storing unit 36.

When the two diverters 40a, 40b respectively take positions as depicted by solid lines shown in FIG. 5, each banknote inserted in the banknote inlet 38a will be sent to the transport path 38b, and then stored in the middle banknote storing unit 32. Meanwhile, when the diverter 40a takes a position as depicted by a dotted line shown in FIG. 5, while the diverter 40b takes the position as depicted by the solid line shown in FIG. 5, each banknote inserted in the banknote inlet 38a will be sent to the transport path 38c, and then stored in the front banknote storing unit 34. Further, when the diverter 40a takes the position as depicted by the solid line shown in FIG. 5, while the diverter 40b takes a position as depicted by a dotted line shown in FIG. 5, each banknote inserted in the banknote inlet 38a will be sent to the transport path 38d, and then stored in the rear banknote storing unit 36.

In this way, with the provision of such diverters 40a, 40b, a switching unit can be provided for suitably switching the banknote storing unit, in which each banknote inserted in the banknote inlet 38a is stored, among the front banknote storing unit 34, rear banknote storing unit 36 and middle banknote storing unit 32. It is noted that each of such diverters 40a, 40b is controlled by the control unit 15 that will be described later. Namely, the control unit 15 can serve to control the respective diverters 40a, 40b, based on the recognition result on each banknote recognized by the recognition unit 18, in order to transport each banknote inserted in the banknote inlet 38a to each corresponding banknote storing unit 32, 34, 36.

As shown in FIG. 5, the middle banknote storing unit 32 is located just below the banknote inlet 38a, and the transport path 38b is provided to extend downward, in a substantially linear form, from the banknote inlet 38a to the middle banknote storing unit 32. In this case, as described above, the middle banknote storing unit 32 can serve to store therein each banknote recognized as the counterfeit banknote by the recognition unit 18 and/or each banknote recognized, as the suspicious banknote about the authentication, by the recognition unit 18. With this configuration of the banknote storing cassette 30, even in the case some banknotes in a rather bad condition, such as folded banknotes or the like, are inserted in the banknote inlet 38a, such banknotes can be smoothly sent to the middle banknote storing unit 32, without being curved. Therefore, this configuration can positively prevent occurrence of an unwanted jam that may be otherwise caused upon the storage of such folded banknotes or the like in the banknote storing cassette 30.

Fin wheels 39, each configured for pushing each banknote, are provided, respectively, to a point between the transport path 38c and the front banknote storing unit 34, as well as to a point between the transport path 38d and the rear banknote storing unit 36. Such fin wheels 39 can serve to push each banknote sent from the transport path 38c to the front banknote storing unit 34 and/or each banknote sent from the transport path 38d to the rear banknote storing unit 36, thus allowing each banknote to be stacked, one on another, in each banknote storing unit 34, 36, with each stacked banknote being horizontally oriented. In other words, such fin wheels 39 can serve to successfully prevent each banknote from being stored, in an undesired vertically-oriented condition, in each of the banknote storing units 34, 36.

In addition, the front banknote storing unit 34 and rear banknote storing unit 36 can be optionally detached from the cassette casing of the banknote storing cassette 30. With this configuration, once the banknote storing cassette 30 is pulled out from the lower casing 11b of the banknote handling machine 10, the front banknote storing unit 34 and/or rear banknote storing unit 36 can be detached from the cassette casing of the banknote storing cassette 30, thereby enabling the banknotes, such as the genuine banknotes or the like, respectively stored in the front banknote storing unit 34 and/or rear banknote storing unit 36, to be readily collected.

Similar to the front banknote storing unit 34 and rear banknote storing unit 36, the middle banknote storing unit 32 may also be optionally detached from the cassette casing of the banknote storing cassette 30. In the case the middle banknote storing unit 32 can be optionally detached from the cassette casing of the banknote storing cassette 30, once the banknote storing cassette 30 is pulled out from the lower casing 11b of the banknote handling machine 10, such a middle banknote storing unit 32 is detached from the cassette casing of the banknote storing cassette 30, thus achieving collection of the banknotes, such as the counterfeit banknotes and/or suspicious banknotes about the authentication, stored in the middle banknote storing unit 32.

Further, a memory 31a is provided to the banknote storing cassette 30. This memory 31a can serve to store therein information on each banknote stored in the front banknote storing unit 34, rear banknote storing unit 36 and middle banknote storing unit 32. More specifically, this memory 31a is provided for receiving the recognition result concerning each banknote recognized by the recognition unit 18 and sent from the control unit 15. With the provision of such a memory 31a in the banknote storing cassette 30, even in the case the banknote storing cassette 30 is pulled out from the lower casing 11b of the banknote handling machine 10 and then moved to a suitable place different from the point at which the banknote handling machine 10 is located, an operator can get any information concerning each banknote stored in the front banknote storing unit 34, rear banknote storing unit 36 and middle banknote storing unit 32, by reading the information stored in the memory 31a. As the information concerning each banknote and stored in the memory 31a, for example, the information on the denomination of each banknote, the number of the stored banknotes or serial number of each banknote, the authentication in regard to the genuine banknotes, counterfeit banknotes or the like, can be mentioned.

Further, the memory 31a is provided with an interface 31b adapted for transmitting the information stored in the memory 31a to the exterior of banknote storing cassette 30, and the information stored in the memory 31a can be transmitted to an external machine via the interface 31b. Therefore, even when the operator is present at any place far away from the point at which the banknote handling machine 10 is located, the operator can get any information stored in the memory 31a by reading the information, while using such an external machine, via cable or wireless transmission, from the interface 31b provided to the banknote storing cassette 30. It is noted that the aforementioned memory 31a and/or interface 31b may be provided to any of the front banknote storing unit 34, rear banknote storing unit 36 and middle banknote storing unit 32.

Further, it is noted that the banknote storing cassette stored in the lower casing 11-b of the banknote handling machine 10 is not limited to such an aspect as including the two banknote storing units 34, 36, respectively configured for storing therein the genuine banknotes. For instance, as shown in FIG. 6, the banknote storing cassette 50 may include a total of four banknote storing units 54, 55, 56, 57, respectively configured for storing therein the genuine banknotes or the like. In this case, the two banknote storing units 54, 55 are located in an upper forward portion and a lower forward portion of the banknote storing cassette 50, respectively, while the other two banknote storing units 56, 57 are located in an upper backward portion and a lower backward portion of the banknote storing cassette 50, respectively. Further, another banknote storing unit 52 configured for storing therein the counterfeit banknotes or suspicious banknotes about the authentication is provided between the lower front banknote storing unit 55 and the lower rear banknote storing unit 57.

Now, referring to FIG. 6, the internal construction of this banknote storing cassette 50 will be further discussed. As shown in FIG. 6, a banknote inlet 58a is provided in a top face of the cassette casing of the banknote storing cassette 50. In this case, each banknote inserted in the banknote inlet 58a can be sent to any one of transport paths 58b, 58d and 58e, by actuation of a first switching unit. This first switching unit is composed of two diverters 60a, 60b. The transport path 58d is connected to the banknote storing unit 54, while the transport path 58e is connected to the banknote storing unit 56. As such, each banknote sent to the transport path 58d or 58e by the first switching unit can be stored in the corresponding banknote storing unit 54 or 56. Further, a second switching unit is connected to the transport path 58b, such that each banknote sent to the transport path 58b by the first switching unit can be further sent to the second switching unit.

In this case, each banknote sent from the transport path 58b to the second switching unit will be sent to any one of transport paths 58c, 58f and 58g, by actuation of the second switching unit. This second switching unit is composed of two diverters 60c, 60d. The transport path 58f is connected to the banknote storing unit 55, while the transport path 58g is connected to the banknote storing unit 57. Thus, each banknote sent to the transport path 58f or 58g by the second switching unit can be stored in the corresponding banknote storing unit 55 or 57. Further, the transport path 58c is connected to the banknote storing unit 52, such that each banknote sent to the transport path 58c by the second switching unit can be stored in the banknote storing unit 52.

The construction and operation of each of the diverters 60a through 60d are substantially the same as the construction and operation of each of the diverters 40a, 40b shown in FIG. 5. The control unit 15 can serve to control the respective diverters 60a through 60d, based on the recognition result on each banknote recognized by the recognition unit 18, thereby to transport each banknote inserted in the banknote inlet 58a to each corresponding banknote storing unit 52 through 57.

As shown in FIG. 6, the banknote storing unit 52 is located just below the banknote inlet 58a, and the transport paths 58b, 58c are respectively provided to extend downward, in the substantially linear form, in succession, from the banknote inlet 58a to the middle banknote storing unit 52. As described above, the banknote storing unit 52 can serve to store therein each banknote recognized as the counterfeit banknote by the recognition unit 18 and/or each banknote recognized, as the suspicious banknote about the authentication, by the recognition unit 18. With this configuration of the banknote storing cassette 50, even in the case some banknotes in a rather bad condition, such as folded banknotes or the like, are inserted in the banknote inlet 58a, such banknotes can be smoothly sent to the banknote storing unit 52, without being curved. Therefore, this configuration can positively prevent occurrence of the unwanted jam that may be otherwise caused upon the storage of such folded banknotes or the like in the banknote storing cassette 50.

Further, as shown in FIG. 6, fin wheels 59, each adapted for pushing each banknote and configured in substantially the same manner as the fin wheels 39 as described above, are provided, respectively, to each point, between the transport path 58d and the banknote storing unit 54, between the transport path 58e and the banknote storing unit 56, between the transport path 58f and the banknote storing unit 55, and between the transport path 58g and the banknote storing unit 57.

It should be noted that the number of the banknote storing units, respectively provided for storing therein the genuine banknotes, is not limited to two or four as described above, but may be one or any other suitable number greater than one.

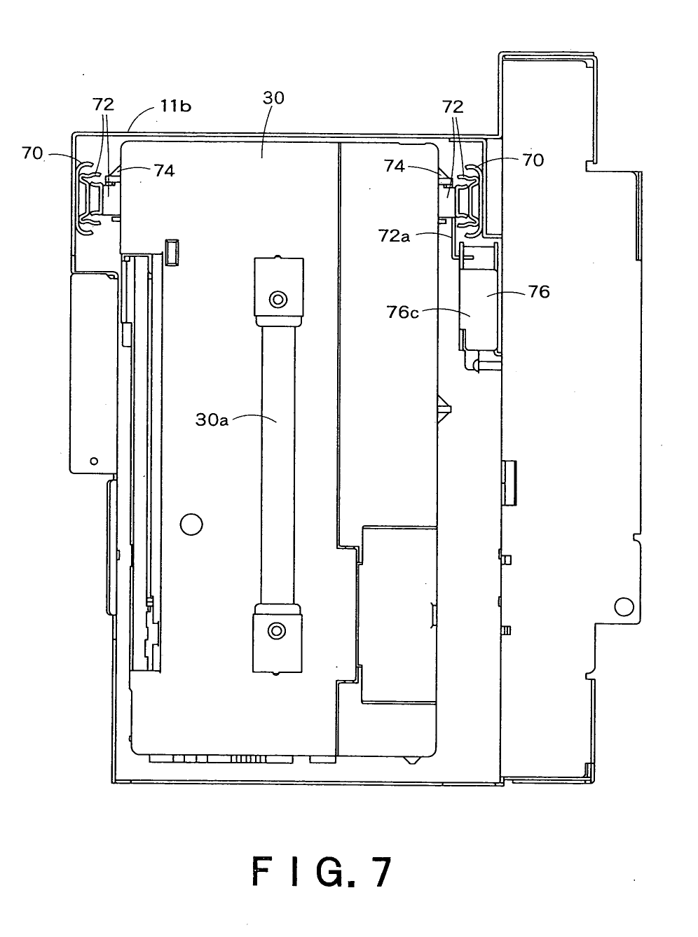

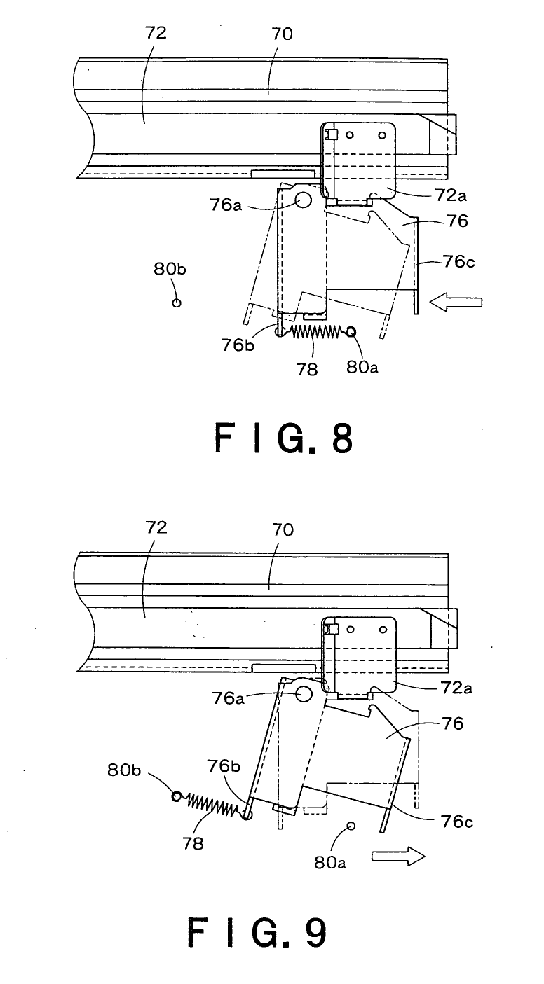

Next, referring to FIGS. 7 through 9, the components, respectively provided for pulling out the banknote storing cassette 30 from the lower casing 11b of the banknote handling machine 10, will be described. Of these drawings, FIG. 7 shows the back view of the banknote storing cassette 30 shown in FIG. 4, when this cassette 30 is seen from the back thereof, while being stored in the banknote handling machine 10 shown in FIG. 1. FIGS. 8 and 9 are respectively provided for illustrating one positional relationship between an engaging member 76 provided to the lower casing 11b of the banknote handling machine 10 and an engaged member 72a provided to a slide rail 72 and configured to be engaged with the engaging member 76.

As shown in FIG. 7, a grasping unit 30a, such as a handle or the like, is attached to the back face of the cassette casing of the banknote storing cassette 30. This handle 30a is provided for allowing the operator to readily pull out the banknote storing cassette 30 from the lower casing 11b of the banknote handling machine 10. Further, a pair of, left and right, rail receiving units 70 are respectively attached to opposite inner side faces of the lower casing 11b of the banknote handling machine 10. Such left and right rail receiving units 70 are respectively configured to receive a pair of, left and right, slide rails 72. Each slide rail 72 is provided to extend in an orthogonal direction relative to the sheet of FIG. 7 (or in a horizontal direction). Further, each slide rail 72 is located between each corresponding side face of the cassette casing of the banknote storing cassette 30 and the corresponding one of the left and right rail receiving units 70 respectively attached to the opposite inner side faces of the lower casing 11b. With such configuration, each slide rail 72 can be moved in the orthogonal direction relative to the sheet of FIG. 7, relative to each corresponding rail receiving unit 70.

Further, a pair of, left and right, guide members 74 are attached to both side faces of the cassette casing of the banknote storing cassette 30. Each guide member 74 is configured to be placed on each corresponding slide rail 72. With this configuration, when the operator moves the banknote storing cassette 30, in the backward direction, while grasping the grasping unit 30a, the banknote storing cassette 30 can be pulled out from the lower casing 11b along the pair of left and right slide rails 72.

As shown in FIGS. 7 through 9, the engaged member 72a is provided to at least one of the pair of left and right slide rails 72. Meanwhile, the engaging member 76; which can engage with the engaged member 72a, is provided to the lower casing 11b of the banknote handling machine 10. As shown in FIG. 8, the engaging member 76 includes an attachment shaft 76a attached to the lower casing 11b, and a spring attachment part 76b configured to be attached to a spring 78 that will be described later. In this case, the engaging member 76 can be pivoted about the attachment shaft 76a. Further, the engaging member 76 includes an operation plate 76c configured to be operated by one or more fingers of the operator. Namely, when the operation plate 76c is pushed forward or pulled backward by the operator, the engaging member 76 is pivoted about the attachment shaft 76a. In this case, when the engaging member 76 takes an engagement position as depicted by a solid line in FIG. 8, the engaging member 76 engages with the engaged member 72a, thereby preventing the slide rail 72 from being moved relative to the lower casing 11b. In this way, only the banknote storing cassette 30 can be pulled out from the lower casing 11, while leaving the slide rail 72 in the lower casing 11b.

Meanwhile, when the engaging member 76 takes a non-engagement position as depicted by a two-dot chain line in FIG. 8, the engaging member 76 does not engage with the engaged member 72a, thus allowing the slide rail 72 to be moved relative to the lower casing 11b. Therefore, the banknote storing cassette 30 can be pulled out, together with the slide rail 72, from the lower casing 11b. Namely, with the pivot movement of the engaging member 76 about the attachment shaft 76a, relative to the lower casing 11b, this engaging member 76 can engage with or be disengaged from the engaged member 72a.

Further, as shown in FIGS. 8 and 9, one end of the spring is attached to the spring attachment part 76b of the engaging member 76. In addition, two spring attachment parts 80a, 80b, respectively configured to be connected with the other end of the spring 78, are provided to the lower casing 11b of the banknote handling machine 10.

In this case, when the other end of the spring 78 is attached to the first spring attachment part 80a and if no force is applied to the operation plate 76c of the engaging member 76 by the operator, as shown in FIG. 8, the engaging member 76 takes the engagement position as depicted by the solid line in FIG. 8. However, once the operator pushes the operation plate 76c of the engaging member 76, in a direction as designated by an arrow in FIG. 8, this engaging member 76 will be moved to the non-engagement position as depicted by the two-dot chain line in FIG. 8.

Meanwhile, when the other end of the spring 78 is attached to the second spring attachment part 80b and if no force is applied to the operation plate 76c of this engaging member 76, as shown in FIG. 9, the engaging member 76 takes the non-engagement position as depicted by a solid line in FIG. 9. However, once the operator pulls the operation plate 76c of the engaging member 76, in a direction as designated by an arrow in FIG. 9, this engaging member 76 will be moved to the engagement position as depicted by a two-dot chain line in FIG. 9.

The attachment of the other end of the spring 78 to either one of the first spring attachment part 80a or second spring attachment part 80b can be readily carried out, by hand, by the operator. Further, the switch of the attachment part to which the other end of the spring 78 is attached, between the two attachment parts 80a, 80b, can also be readily performed, by hand, by the operator. Thus, when pulling out the banknote storing cassette 30 from the lower casing 11b of the banknote handling machine 10, the operator can optionally attach the other end of the spring 78 to either one of the first and second spring attachment parts 80a, 80b, by hand, with ease, depending on the difference in frequency in the use, between the operation for taking out the banknote storing cassette 30 together with the slide rail 72 and the operation for pulling out only the banknote storing cassette 30, while leaving the slide rail 72 in the lower cassette 11b.

Now, referring to FIG. 3, the control unit 15 adapted for controlling the respective components of the banknote handling machine 10 will be discussed. FIG. 3 is the block diagram provided for illustrating the control system of the banknote handling machine 10 shown in FIG. 1. In this case, the control unit 15 is provided in the upper casing 11a of the banknote handling machine 10. As shown in FIG. 3, the control unit 15 is connected with each of the banknote inlet unit 12, banknote stacking unit 14, banknote feeding unit 16, recognition unit 18, escrow unit 20, transport unit 22, diverters 24, diverters 40a, 40b, interface 15a provided for communicating with the external machine, such as a host machine or the like of the banknote handling machine 10, and memory 31a provided to the banknote storing cassette 30. As described above, the memory 31a is connected with the interface 31b adapted for communicating with the external machine.

The control unit 15 can serve to receive the recognition result on each banknote recognized by the recognition unit 18. Further, this control unit 15 is configured to control each of the banknote inlet unit 12, banknote stacking unit 14, banknote feeding unit 16, recognition unit 18, escrow unit 20, transport unit 22, diverters 24, diverters 40a, 40b and the like. Namely, this control unit 15 is provided for controlling each component, in order to ensure well controlled handling for each banknote in the banknote handling machine 10. Further, the provision of the interface 15a connected with the control unit 15 can allow any necessary information to be transmitted, relative to the external machine (e.g., a host computer), via the cable or wireless transmission. In addition, the control unit 15 can serve to send the recognition result on each banknote recognized by the recognition unit 18 to the memory 31a of the banknote storing cassette 30, thereby storing the information on each banknote in this memory 31a.

Next, the operation of the banknote handling machine 10 constructed as described above will be discussed.

To begin with, a deposit and store process for the banknotes in the banknote handling machine 10 will be described. First, the customer or the like inserts the batch of the banknotes in the banknote inlet 12a of the banknote inlet unit 12. Then, the batch of the banknotes inserted in the banknote inlet unit 12 is sent to the banknote feeding unit 16 through the banknote stacking unit 14, and such banknotes are fed out, one by one, from the banknote feeding unit 16 toward the transport unit 22. Thereafter, the transport unit 22 transports the banknotes, one by one, while each transported banknote is recognized, by the recognition unit 18, about the denomination, authentication, fitness and like thereof. Then, the recognition result on each banknote recognized by the recognition unit 18 is sent to the control unit 15. In this case, the banknotes respectively recognized by the recognition unit 18 are sorted into the genuine banknotes, counterfeit banknotes, suspicious banknotes about the authentication, rejected banknotes and the like. In addition, the genuine banknotes are further denominated.

Thereafter, the banknotes respectively recognized by the recognition unit 18 are transported to the escrow unit 20 by the transport unit 22, and then escrowed in the escrow unit 20. When an instruction of depositing the banknotes is given to the control unit 15, the rejected banknotes are returned to the banknote stacking unit 14 by the transport unit 22, based on the recognition result on each banknote recognized by the recognition unit 18, and then stacked in the banknote stacking unit 14. Thereafter, such stacked banknotes are sent, in the batch form, to the banknote inlet unit 12 from the banknote stacking unit 14. In this way, the batch of the rejected banknotes is returned, collectively, to the exterior from the banknote inlet 12a. Meanwhile, the banknotes other than the rejected banknotes, among the banknotes escrowed in the escrow unit 20, are transported to the banknote storing cassette 30 by the transport unit 22. Then, with the operation of each diverter 40a, 40b, respectively controlled by the control unit 15, based on the recognition result on each banknote recognized by the recognition unit 18, the genuine banknotes, among the banknotes transported to the banknote storing cassette 30, are sent to the front banknote storing unit 34 or rear banknote storing unit 36, for example, by denomination thereof. Meanwhile, the counterfeit banknotes or suspicious banknotes about the authentication, among the banknotes transported to the banknote storing cassette 30, are sent to the middle banknote storing unit 32.

Thereafter, the operator pulls out the banknote storing cassette 30 from the lower casing 11b of the banknote handling machine 11b. At this time, if the engaging member 76 provided to the lower casing 11b engages with the engaged member 72a of the slide rail 72, only the banknote storing cassette 30 is pulled out from the lower casing 11b of the banknote handling machine 10, while the slide rail 72 remains fixed in position and thus left in the lower casing 11b. Meanwhile, if the engaging member 76 provided to the lower casing 11b does not engage with the engaged member 72a of the slide rail 72, the banknote storing cassette 30 is pulled out, together with the slide rail 72, from the lower casing 11b of the banknote handling machine 10.

After the banknote storing cassette 30 is pulled out from the lower casing 11b of the banknote handling machine 10, the operator collects the genuine banknotes from the front banknote storing unit 34 and/or rear banknote storing unit 36 of the banknote storing cassette 30, while collecting the counterfeit banknotes or suspicious banknotes about the authentication from the middle banknote storing unit 32. Such correction of the banknotes from the banknote storing cassette 30 may be carried out beside the point at which the banknote handling machine 10 is located, or otherwise may be carried out in any suitable place far away from the banknote handling machine 10. In this way, the deposit and store process for the banknotes in the banknote handling machine 10 is ended.

Next, a deposit and return process for the banknotes in the banknote handling machine 10 will be described. During the deposit and store process as described above, if an instruction of returning the banknotes, in place of the instruction of depositing the banknotes, is given to the control unit 15 after the banknotes are escrowed in the escrow unit 20, such banknotes once escrowed in the escrow unit 20 are all returned to the banknote stacking unit 14 by the transport unit 22, and then stacked in the stacking unit 14. Thereafter, such stacked banknotes are sent, in the batch form, to the banknote inlet unit 12 from the banknote stacking unit 14. Thus, the batch of the banknotes is returned, collectively, to the exterior from the banknote inlet 12a. In this way, the deposit and return process for the banknotes is ended.

Next, a deposit and count process for the banknotes in the banknote handling machine 10 will be described. First, the customer or the like insert the batch of the banknotes in the banknote inlet 12a of the banknote inlet unit 12. Then, the batch of the banknotes inserted in the banknote inlet unit 12 is sent to the banknote feeding unit 16 through the banknote stacking unit 14, and such banknotes are fed out, one by one, from the banknote feeding unit 16 toward the transport unit 22. Thereafter, the transport unit 22 transports the banknotes, one by one, while each transported banknote is recognized, by the recognition unit 18, about the denomination, authentication, fitness and like thereof. At this time, the recognition unit 18 also counts the number of the banknotes, by denomination. Then, the recognition result on each banknote recognized by the recognition unit 18 is sent to the control unit 15.

Thereafter, the banknotes once recognized by the recognition unit 18 are respectively transported to the banknote stacking unit 14 by the transport unit 22, and then stacked in the banknote stacking unit 14. Thereafter, such stacked banknotes are sent, in the batch form, to the banknote inlet unit 12. Thus, the batch of the banknotes is returned, collectively, to the exterior from the banknote inlet 12a. In this way, the deposit and count process for the banknotes is ended.

Next, a store process for storing the banknotes left inadvertently, in the banknote handling machine 10, will be described. In this process, after the batch of the banknotes is returned to the banknote inlet 12a of the banknote inlet unit 12, upon the deposit and store process, deposit and return process or deposit and count process, as described above, and if this returned batch of the banknotes is not taken out from the banknote inlet 12a, for a certain period of time, by the customer or the like, the banknote inlet unit 12 is operated to take in and send again such a returned batch of the banknotes to the banknote stacking unit 14. Thereafter, this batch of the banknotes is sent to the banknote feeding unit 16 from the banknote stacking unit 14, and then such banknotes are fed out, one by one, from the banknote feeding unit 16 toward the transport unit 22. Thereafter, the transport unit 22 transports the banknotes, one by one, to the escrow unit 20, and then these banknotes are escrowed in the escrow unit 20. In this case, such banknotes escrowed in the escrow unit 20 are all sent to the middle banknote storing unit 32 of the banknote storing cassette 30. In this store process for storing the banknotes left inadvertently, in the banknote handling machine 10, the banknotes once fed to the transport unit 22 from the banknote feeding unit 16 may be directly sent to the banknote storing cassette 30, without being transported through the recognition unit 18. Namely, such a process eliminates the need for escrowing each banknote in the escrow unit 20. Therefore, such a banknote will not be curved around the drum 20a of the escrow unit 20. In this case, each banknote fed to the transport unit 22 from the banknote feeding unit 16 may be transported to the banknote storing cassette 30, through a route other than the transport path for transporting the banknotes to the escrow unit 20 via the recognition unit 18 (e.g., through the route provided, as shown in FIG. 2, below the transport path along which the recognition unit 18 is provided). Thus, in addition to the counterfeit banknotes and/or suspicious banknotes about the authentication, the banknotes, once returned to the banknote inlet 12a of the banknote inlet unit 12 and then left therein inadvertently, by the customer or the like, are also stored in the middle banknote storing unit 32. In this way, this store process for storing the banknotes left inadvertently is ended.

As described above, according to the banknote storing cassette 30 of this embodiment, at least one of the front banknote storing unit 34 and rear banknote storing unit 36 can serve to store therein the genuine banknotes, while the middle banknote storing unit 32 can serve to store therein the counterfeit banknotes or suspicious banknotes about the authentication. Further, each banknote inserted in the banknote inlet 38a provided to the cassette casing can be sent, selectively, to any one of the front banknote storing unit 34, rear banknote storing unit 36 and middle banknote storing unit 32. With such configuration, in which the front banknote storing unit 34 and rear banknote storing unit 36 respectively adapted for storing therein the genuine banknotes and the middle banknote storing unit 32 adapted for storing therein the counterfeit banknotes or suspicious banknotes about the authentication are collectively stored in the single banknote storing cassette 30, the task of collecting the banknotes from the banknote handling machine 10 can be performed, all at once, thereby significantly enhancing the efficiency of the task of collecting the banknotes from the banknote handling machine 10.

Further, according to the banknote handling machine 10 including the banknote storing cassette 30 as described above, this banknote storing cassette 30 can be optionally detached from the lower casing 11b of the banknote handling machine 10. Therefore, when collecting the banknotes from the banknote handling machine 10, the genuine banknotes and counterfeit banknotes or suspicious banknotes about the authentication can be collected, respectively, from each corresponding banknote storing unit 32, 34, 36 of the banknote storing cassette 30, in any suitable place, by detaching the banknote storing cassette 30 from the lower casing 11b of the banknote handling machine 10 and then carrying this banknote storing cassette 30 to the place. Accordingly, the efficiency of the task of recovering the banknotes from the banknote handling machine 10 can be securely enhanced.

In addition, even in the case the banknote storing cassette 30 is pulled out from the lower casing 11b of the banknote handling machine 10 and then moved to any suitable place different from the point at which the banknote handling machine 10 is located, the provision of the memory 31a to the banknote storing cassette 30 can enable the operator to optionally get the information concerning each banknote stored in the front banknote storing unit 34, rear banknote storing unit and middle banknote storing unit 32, by reading the information stored in the memory 31a. More specifically, this memory 31a is provided with the interface 31b adapted for transmitting the information stored in the memory 31a to the exterior of banknote storing cassette 30. Thus, via such an interface 31b, the information stored in this memory 31a can be transmitted to the external machine. Therefore, even though being far away from the point at which the banknote handling machine 10 is located, the operator can get any information stored in the memory 31a, by utilizing such an external machine to read the information, via the cable or wireless transmission, from the interface 31b provided to the banknote storing cassette 30.

It should be appreciated that the banknote handling machine 10 of this invention and the banknote storing cassette 30 provided to the banknote handling machine 10 are not limited, respectively, to such aspects as described above, but various modifications and/or alterations can be made thereto.

For instance, one of the front banknote storing unit 34 and rear banknote storing unit 36 in the banknote storing cassette 30 can serve to store therein the genuine banknotes, while the other banknote storing unit may be provided for storing therein the counterfeit banknotes or suspicious banknotes about the authentication, or otherwise the other banknote storing unit may be provided for storing therein both the genuine banknotes and suspicious banknotes about the authentication in combination. Alternatively, one of the two banknote storing units 34, 36 can serve to store therein the banknotes of a certain denomination, while the other banknote storing unit may be provided for storing therein the banknotes of denominations other than the certain denomination in combination. Alternatively, one of the two banknote storing units 34, 36 can serve to store therein the banknotes of certain denominations in combination, while the other banknote storing unit may be provided for storing therein the banknotes of denominations other than the certain denominations in combination. Alternatively, one of the two banknote storing units 34, 36 can serve to store therein the fit banknotes, while the other banknote storing unit may be provided for storing therein unfit banknotes.

Further, instead of the case that the genuine banknotes, among the banknotes inserted in the banknote inlet 38a of the banknote storing cassette 30, are stored in the front banknote storing unit 34 and rear banknote storing unit 36, while such genuine banknotes are sorted by denomination of money thereof, the genuine banknotes of all denominations of money may be stored first in one of the two banknote storing units (e.g., the front banknote storing unit 34), and then the remaining genuine banknotes may be stored in the other banknote storing unit, after the one banknote storing unit is filled with the genuine banknotes.

1. A banknote storing cassette, comprising:
a cassette casing;
a banknote inlet provided to the cassette casing;
one or more first banknote storing units, to which one or more banknotes inserted in the banknote inlet are sent, at least one of the one or more first banknote storing units storing therein genuine banknotes; and
a second banknote storing unit, to which one or more banknotes inserted in the banknote inlet are sent, the second banknote storing unit storing therein counterfeit banknotes or suspicious banknotes about the authentication.

2. The banknote storing cassette according to claim 1, further comprising a switching unit configured to switch the banknote storing unit to which one or more banknotes inserted in the banknote inlet are sent, between the first banknote storing unit and the second banknote storing unit.

3. The banknote storing cassette according to claim 1, wherein a transport path from the banknote inlet to the second banknote storing unit is provided in a substantially linear form.

4. The banknote storing cassette according to claim 3, wherein the banknote inlet is provided in a top face of the cassette casing and the second banknote storing unit is located below the banknote inlet.

5. The banknote storing cassette according to claim 1, further comprising a memory unit configured to store therein information concerning the banknotes respectively stored in the one or more first banknote storing units and the second banknote storing unit.

6. The banknote storing cassette according to claim 5, further comprising a transmission unit configured to transmit the information stored in the memory unit to the exterior of the banknote storing cassette.

7. The banknote storing cassette according to claim 1, wherein the one or more first banknote storing units are optionally detachable from the cassette casing.

8. The banknote storing cassette according to claim 1, wherein the second banknote storing unit is optionally detachable from the cassette casing.

9. A banknote handling machine, comprising:
a main-body casing;
a banknote inlet unit provided to the main-body casing;
a transport unit provided in the main-body casing and configured to transport each banknote inserted in the banknote inlet unit, in the main-body casing;
a recognition unit provided to the transport unit and configured to recognize each banknote transported by the transport unit; and
the banknote storing cassette according to claim 1 and connected to the transport unit to receive the banknotes respectively transported from the transport unit,
wherein the banknote storing cassette is optionally detachable from the main-body casing, and
each banknote transported to the banknote storing cassette is sent to any one of the one or more first banknote storing units and the second banknote storing unit, based on a recognition result on the banknote recognized by the recognition unit.

10. The banknote handling machine according to claim 9,
wherein a slide rail extending in a substantially horizontal direction is provided in the main-body casing,
a guide member configured to be placed on the slide rail is attached to a side face of the cassette casing of the banknote storing cassette, and
the banknote storing cassette is able to be pulled out from the main-body casing, along the slide rail, by moving the banknote storing cassette in the substantially horizontal direction.

11. The banknote handling machine according to claim 10,
wherein the slide rail is movable relative to the main-body casing, and is provided with an engaged member,
an engaging member that is engageable with the engaged member is provided to the main-body casing, and
when the engaging member engages with the engaged member, the slide rail becomes fixed to the main-body casing, and when the engaging member is disengaged from the engaged member, the slide rail is able to be pulled out, together with the banknote storing cassette, from the main-body casing.

12. The banknote handling machine according to claim 11, wherein the engaging member is able to be pivoted, about an attachment shaft, relative to the main-body casing, and the engaging member is engageable with or disengageable from the engaged member by pivoting the engaging member about the attachment shaft.

13. The banknote handling machine according to claim 9,
wherein the banknote handling machine further comprises an escrow unit provided in the main-body casing and configured to escrow therein the banknotes, and
each banknote recognized by the recognition unit is escrowed in the escrow unit, and then the escrowed banknote is transported to the banknote storing cassette by the transport unit.
